(19) United States
(12) Patent Application Publication
(10) Pub. No.: US 2025/0362666 A1
(43) Pub. Date: Nov. 27, 2025

(54) ROBOTIC PICK AND PLACE SYSTEM

(71) Applicant: ROCKWELL AUTOMATION TECHNOLOGIES, INC., Mayfield Heights, OH (US)

(72) Inventors: Hua He, Shanghai (CN); Zhou Wu, Shanghai (CN); Xiangyu Zhang, Shanghai (CN); Yuan Wang, Shanghai (CN); Fuda Guo, Shanghai (CN); Qisheng Zhang, Shanghai (CN)

(73) Assignee: ROCKWELL AUTOMATION TECHNOLOGIES, INC., Mayfield Heights, OH (US)

(21) Appl. No.: 19/216,507

(22) Filed: May 22, 2025

Related U.S. Application Data
(60) Provisional application No. 63/651,147, filed on May 23, 2024.

(51) Int. Cl. G05B 19/418; B65G 1/137

(52) U.S. Cl. CPC G05B 19/41865; B65G 1/1371; G05B 2219/45047

(57) ABSTRACT

A method for producing and sorting multiple products includes obtaining job data indicating a size and number of each of the products to be produced and sorted. The method also includes determining, based on both (i) the size and number of each of the products, and (ii) an available amount of space in a loading area, an order of production for the products. The method also includes causing a manufacturing system to produce each of the products according to the order of production, and operating a robotic apparatus to move each of the products into a target location in the loading area based on the order of production of the products.

### CROSS-REFERENCE TO RELATED PATENT APPLICATION

This application claims the benefit of and priority to U.S. Provisional Application No. 63/651,147, filed May 23, 2024, the entire disclosure of which is incorporated by reference herein.

### BACKGROUND

The present disclosure relates generally to a robotic system. More specifically, the present disclosure relates to a robotic system for moving assets from one location to another.

Robotic systems are commonly used for a wide variety of industrial applications including manufacturing, assembly, transportation, material handling, processing operations, and others. In an automated factory or manufacturing environment, robotic systems can be used to manufacture components, move components from one location to another, and package components for shipping or distribution. Many robotic systems are limited by their design, programming, operating environment, or other constraints that prevent the robotic system from operating as efficiently as possible or otherwise lead to suboptimal results. For example, if a robotic system is tasked with picking components from an assembly line and moving the components to a destination, the robotic system may be constrained by the order in which the components arrive on the assembly line, spatial constraints of the destination, the sizes and shapes of the components, and other factors which may prevent the robotic system from organizing the components efficiently.

### SUMMARY

One implementation of the present disclosure is a method for producing and sorting multiple products, according to some embodiments. In some embodiments, the method includes obtaining job data indicating a size and number of each of the products to be produced and sorted. In some embodiments, the method also includes determining, based on both (i) the size and number of each of the products, and (ii) an available amount of space in a loading area, an order of production for the products. In some embodiments, the method includes causing a manufacturing system to produce each of the products according to the order of production, and operating a robotic apparatus to move each of the products into a target location in the loading area based on the order of production of the products.

In some embodiments, determining the order of production for the products includes determining a stacking arrangement for the products based on the size and number of each of the products and the available amount of space in the loading area. In some embodiments, the order of production is determined based on the stacking arrangement.

In some embodiments, determining the stacking arrangement includes determining a first arrangement of a first subset of the products that optimizes usage of an available amount of space within a first layer of the loading area. In some embodiments, the method includes determining a second arrangement of a second subset of the products that optimizes usage of an available amount of space within a second layer of the loading area. In some embodiments, the method includes determining an arrangement of the second layer relative to the first layer in the loading area. In some embodiments, the second layer includes the second subset of the products forming the second layer stacked on top of the first subset of the products that form the first layer.

In some embodiments, determining the stacking arrangement includes determining a first column of a first subset of the products stacked on top of each other. In some embodiments, the method includes determining a second column of a second subset of the products stacked on top of each other, and determining an arrangement of the first column relative to the second column that optimizes usage of an available amount of space within the loading area.

In some embodiments, determining the stacking arrangement includes performing an optimization process that optimizes a use of the available amount of space in the loading area by stacking smaller products on top of larger products. In some embodiments, the loading area includes a three-dimensional space and the stacking arrangement includes a three-dimensional location of each of the products within the three-dimensional space.

In some embodiments, the manufacturing system includes a computer numerical control (CNC) system. In some embodiments, one or more of the products include a different shape or a different size than at least one other of the products.

In some embodiments, the method further includes determining the target location of each of the products within the available amount of space. In some embodiments, the robotic apparatus is configured to move each of the products to the target location as the products are produced.

In some embodiments, the target location of each of the products is determined based on a division of the available amount of space in the loading area into multiple three-dimensional subspaces. In some embodiments, the order of production causes the manufacturing system to produce the products in a sequence that allows the robotic apparatus to move each of the products to a corresponding location in the loading area as each of the products are provided in sequence without requiring rearrangement of any other of the products produced previously.

Another implementation of the present disclosure is a system for producing and sorting products, according to some embodiments. In some embodiments, the method includes a manufacturing system configured to output the products, a loading area, a robotic implement, and processing circuitry. In some embodiments, the loading area defines a space within which the products can be stored. In some embodiments, the robotic implement is configured to move each of the products to a target location in the loading area. In some embodiments, the processing circuitry is configured to obtain job data indicating a size and quantity of the products. In some embodiments, the processing circuitry is further configured to determine, based on the size and quantity of the products and the space of the loading area, a production order of the products, and the target location for each of the products within the loading area. In some embodiments, the processing circuitry is configured to provide the production order of the products to the manufacturing system to cause the manufacturing system to produce the products according to the production order. In some embodiments, the processing circuitry is configured to operate the robotic implement based on both the production order and the target location for each of the products to move each of the products to the target location of the loading area.

In some embodiments, the size of each of the products includes a three-dimensional size indicating a volume of space that each of the products will occupy when placed at the target location in the loading area. In some embodiments, the target location is determined by the processing circuitry by dividing the loading area into multiple boxes, each of the boxes divided into slots, columns, blocks, and levels, the target location including an indication of which of other of the products a corresponding product is stacked upon.

In some embodiments, determining the target location for each of the products includes a position of each of the products in one or more stacks of the products. In some embodiments, the processing circuitry is further configured to communicate with the manufacturing system and the robotic implement to obtain feedback indicating progress of a completion of a job for the job data. In some embodiments, the processing circuitry is configured to operate a user interface to display the progress of the job including a graphical representation of the products each positioned at the target locations in the loading area.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a block diagram of a manufacturing and sorting system, according to some embodiments.

FIG. 2 is a block diagram of a control system for the manufacturing and sorting system of FIG. 1, according to some embodiments.

FIG. 3 is a diagram of a top view of a loading area into which products produced by the manufacturing and sorting system of FIG. 1 are placed, according to some embodiments.

FIG. 4 is another diagram of a top view of the loading area of FIG. 3, according to some embodiments.

FIG. 5 is a front view of the loading area of FIG. 3, according to some embodiments.

FIG. 6 is a block diagram of a controller of the control system of FIG. 2, according to some embodiments.

FIG. 7 is a flow diagram of a process for producing and stacking products, according to some embodiments.

FIG. 8 is a graphical user interface of a dashboard for the control system of FIG. 2, according to some embodiments.

FIG. 9 is a graphical user interface of simulation results the control system of FIG. 2, according to some embodiments.

FIG. 10 is a graphical user interface showing a visual representation of the simulation results of FIG. 9, according to some embodiments.

FIG. 11 is a graphical user interface for product unloading and monitoring for the system of FIG. 1, according to some embodiments.

FIG. 12 is a graphical user interface for skipping a part in the production and sorting process implemented by the system of FIG. 1, according to some embodiments.

FIG. 13 is a graphical user interface for prompting a user to switch a frame of the loading area of FIG. 3, according to some embodiments.

FIG. 14-16 are graphical user interface for managing job implementation of the system of FIG. 1, according to some embodiments.

FIG. 17 is a graphical user interface for showing details of current and historical work order of the system of FIG. 1, according to some embodiments.

FIG. 18 is a graphical user interface showing information of raw materials for the system of FIG. 1, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, a production system includes processing machinery (e.g., factory equipment) and a robotic implement. The production system also includes a control system that is configured to obtain job data indicating requested products (e.g., size, quantity, etc.). The control system performs a sorting process to determine a stacking arrangement for the finished products including a target location for each product in a loading area. The control system uses the stacking arrangement to determine an order or sequence of production and stacking of the products. The control system uses the order or sequence to control both the processing machinery and the robotic implement to produce and stack the products according to the sequence or order.

### System Overview

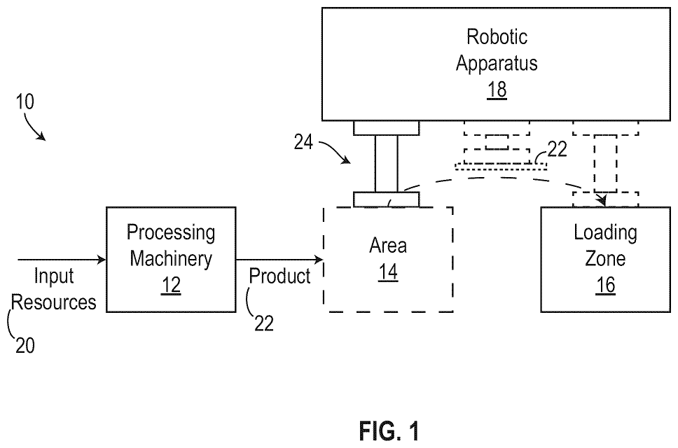

Referring to FIG. 1, a processing system 10 includes processing machinery 12, an area 14, a robotic apparatus 18, and a loading zone 16, according to some embodiments. The processing machinery 12 is configured to receive one or more input resources 20 (e.g., raw materials, unrefined materials, copper, aluminum, steel, etc.) and output a complete product (e.g., a refined materials, a processed material, a cut piece of product, etc.), according to some embodiments. The processing machinery 12 may include one or more Computer Numerical Control (“CNC”) machines, lathes, laser cutters, or other machinery for processing the input resources 20 (e.g., raw materials). The processing machinery 12 is configured to implement one or more cutting, refining, etc., operations, and output the product 22 to the area 14, according to some embodiments. The area 14 may be an output belt, a tray, etc., or any other intermediate storage and processing area. The robotic apparatus 18 includes an implement 24 configured to extend and retract or otherwise move, according to some embodiments. The implement 24 is configured to releasably grasp the product 22 from the area 14, lift the product 22 to the loading zone 16, and release the product 22 at the loading zone 16 in a desired area, according to some embodiments. The robotic apparatus 18 may be configured to implement a sorting algorithm in order to determine locations for each of the product 22 to optimize a space constraint of the loading zone 16.

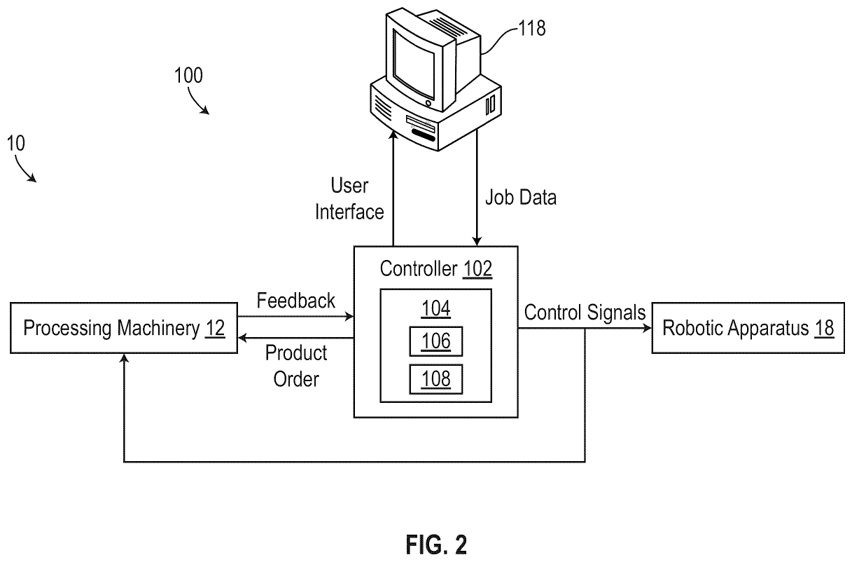

Referring to FIG. 2, the processing system 10 includes a control system 100 that is configured to operate the robotic apparatus 18, according to some embodiments. The control system 100 includes a controller 102 includes processing circuitry 104, a processor 106, and memory 108. Processing circuitry 104 can be communicably connected to a communications interface such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by processing circuitry 104 and/or processor 106) one or more processes described herein. The controller 102 can include non-transitory computer readable medium (e.g., the memory 108) configured to store instructions that, when executed by the processing circuitry 104 or the processor 106 cause the processing circuitry 104 or processor 106 to perform one or more operations described herein.

In some embodiments, controller 102 is implemented within a single computer (e.g., one server, one housing, etc.). In various other embodiments, controller 102 can be distributed across multiple servers or computers (e.g., that can exist in distributed locations) such as on processing circuitry of a cloud computing system.

The controller 102 is configured to receive feedback from the processing machinery 12 and job data from a user computer 118 (e.g., a system administrator's computer, a job manager's computer, a backend system, a remote computing system, etc.), according to some embodiments. The controller 102 may be configured to provide a user interface to the user computer 118 that displays various data regarding current implementation of a job for the job data (e.g., number of parts completed, parts or products remaining to be manufactured, stacks of different parts in the loading zone 16, etc.).

The job data provided by the user computer 118 indicates various order data such as parts to be manufactured, and which order number the parts are associated with, according to some embodiments. The job data includes both a type (e.g., including dimensions, size, shape, etc.) and quantity of each type of product, according to some embodiments. Each order number (for different customers or different batches) includes the type and quantity for each type of product, according to some embodiments. The dimensions may include overall height, width, and length of the product. The controller 102 is configured to use the job data for the multiple orders (e.g., the type and quantity of each type of product for each order) and determine a stacking arrangement for the products of the job data, according to some embodiments. The stacking arrangement may be determined by the controller 102 based on known size and space constraints of the loading zone 16. The controller 102 may implement a sorting or stacking algorithm by using the known sizes and shapes of each product, identifying locations to stack the products on top of each other while satisfying space constraints of the loading zone 16, and ensuring that one or more constraints are met (e.g., a product with a larger size is not stacked on top of a product with a smaller size to reduce a likelihood of tipping).

Based on the stacking arrangement for the products of the job data, the controller 102 is configured to determine a sequence in which the products should be stacked in order to achieve the stacking arrangement, according to some embodiments. For example, the controller 102 may determine a target location and sequence for each of the products, starting on a bottom layer, then proceeding to a second layer, etc. The sequence in which the products should be stacked may be provided as a product sequence to the processing machinery shown in FIG. 2. The processing machinery 12 is configured to receive the product sequence from the controller 102 and manufacture or process the products according to the order, according to some embodiments. The controller 102 uses the target location and the sequence to determine control signals for the robotic apparatus 18, according to some embodiments. In this way, the operation of the processing machinery 12 to produce or output the products, and the operation of the robotic apparatus 18, are integrated by the controller 102 such that the processing machinery 12 and the robotic apparatus 18 are operated in a coordinated manner to achieve produced products according to the stacking arrangement, according to some embodiments. Integrating the operation of the processing machinery 12 with the robotic apparatus 18 (e.g., integrating the order of manufacturing with the order or sequence of stacking to achieve a desired stacking arrangement) facilitates improved performance and efficiency of the processing system 10, according to some embodiments.

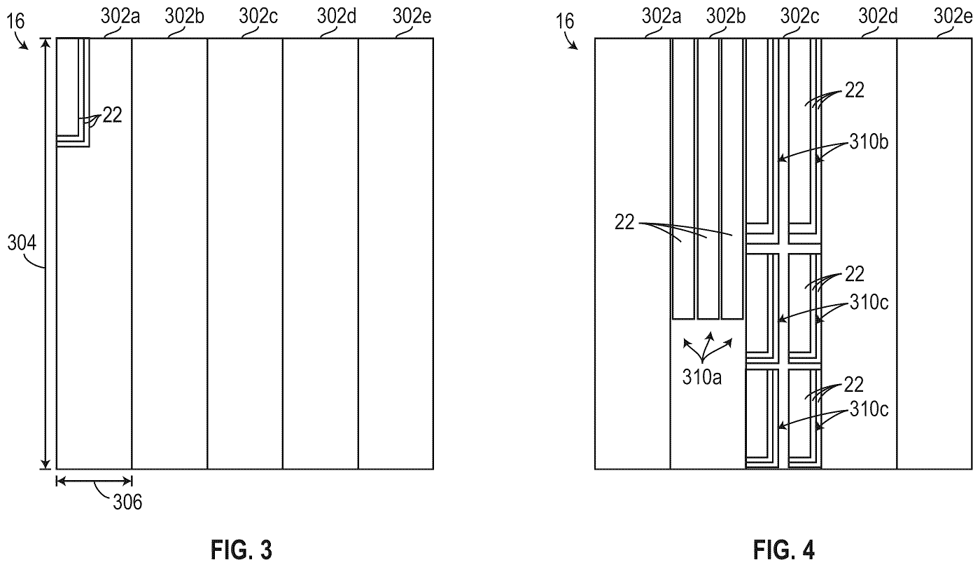

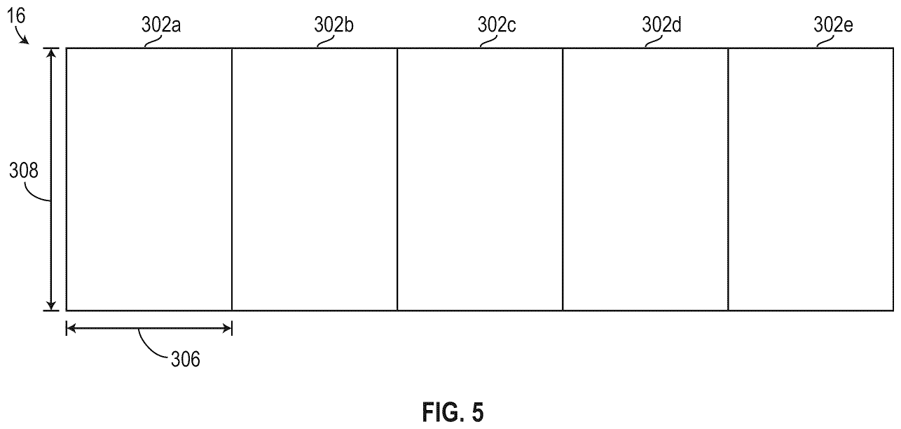

Referring particularly to FIGS. 3-5, the loading area 16 is shown in greater detail, according to some embodiments. The loading zone 16 may include multiple partitions, boxes, etc., shown as boxes 302a-302e. The boxes 302a-302e may each have walls (e.g., boundaries or barriers) that are either physical or virtual (e.g., defined for software implemented by the controller 102). The boxes 302a-302e may define different spaces within which different orders are fulfilled. The boxes 302a-302e each have a length 304, a width 306, and a height 308, and thereby provide a space, according to some embodiments. In some embodiments, the boxes 302a-302e are pallets or members that can be fully packaged, lifted, and loaded onto a vehicle for transportation.

Referring still to FIGS. 3-5, the controller 102 may divide the boxes 302a-302e into columns, levels, and blocks. The columns may be formed from successively stacking products 22 onto one another by the robotic apparatus 18. The columns may be constrained by the width 306 of the boxes 302a-302e, or may be constrained by an overall width of the loading area 16 (e.g., by outer walls of the frame of the loading area 16). The levels include all the products 22 that are placed on the same level or stacked at the same vertical position relative to other products 22 (e.g., a bottom level, a second level on top of the bottom level, a third level on top of the second level, etc.), according to some embodiments. A number of levels are constrained based on the height 308 of the loading area 16 (e.g., the frame of the loading area), according to some embodiments. For example, each column may have multiple levels (e.g., in a vertical direction). The blocks are each product 22 that is stacked to form the columns at the different levels, according to some embodiments. The blocks may be constrained based on the length 304 of the loading area 16. The controller 102 may also implement a weight constraint for the loading area 16 that is based on a density or known weight of each product. For example, the loading area 16 may be limited to a weight or mass of 1,000 kilograms and the controller 102 may limit further stacking of the product 22 in the loading area 16 once the loading area 16 reaches 1,000 kilograms of products 22. In some embodiments, the height 308 is 80 centimeters.

Referring to FIG. 4, the loading area 16 is shown with multiple first columns 310a of the product 22 in the second box 302b, according to some embodiments. The first columns 310a may include a stack of multiple levels of the products 22 and are determined by the controller 102 based on the available space in the second box 302b (e.g., a subset of the overall space available in the loading area 16), according to some embodiments. The first columns 310a are formed by uniformly sized products 22 that can therefore be stacked on top of each other (e.g., since none of the subsequent or higher up levels of products 22 will have a larger area than lower levels), according to some embodiments. Referring still to FIG. 4, the box 302c includes second columns 310b of products 22, and third columns 310c of products 22, according to some embodiments. As shown in FIG. 4, the second columns 310b and the third columns 310c include three levels, with largest of the product 22 on the bottom level, according to some embodiments. The controller 102 is configured to determine which products 22 should be placed on which level of each columns 310b or 310c based on the size of the products 22 on the lower levels, according to some embodiments. The controller 102 is also configured to determine where the columns 310b and 310c should be positioned relative to each other in order to optimally use the space in the loading area 16, according to some embodiments. In some embodiments, the controller 102 is configured to determine which products 22 should be placed on which level of the columns 310b or 310c by placing a largest product 22 (e.g., in terms of footprint) on the lowest level, and subsequently stacking the next largest product (in terms of footprint) on the next level. The controller 102 may implement a simulation or optimization to determine where to place the columns 310b or 310c.

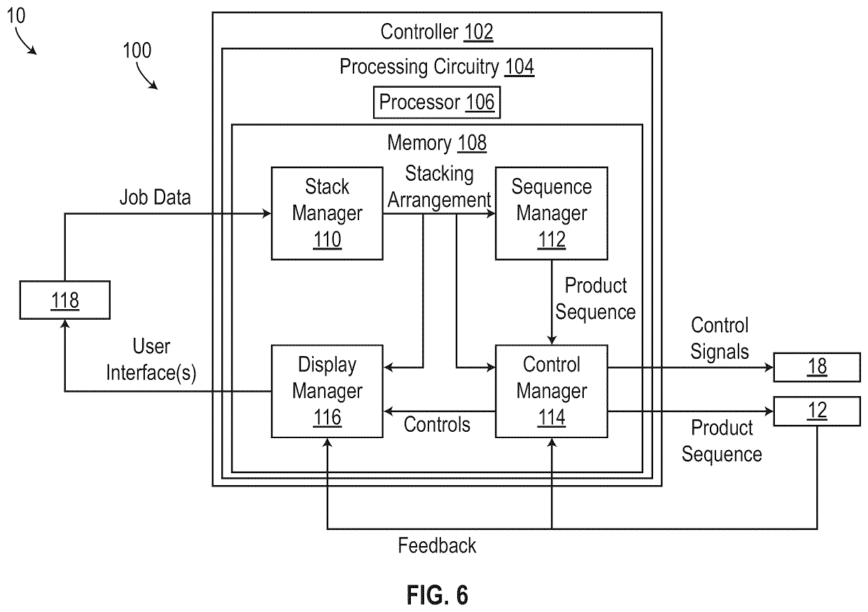

Referring to FIG. 6, the controller 102 is shown in greater detail, according to some embodiments. The controller 102 includes a stack manager 110, a sequence manager 112, a control manager 114, and a display manager 116, according to some embodiments. The stack manager 110 receives the job data from the user interface 118 (e.g., a management system) and determines a stacking arrangement for the products requested in the job data, according to some embodiments. The job data includes the size (e.g., height, length, width) of multiple products to be produced, according to some embodiments. Each product may be tagged with an order number if required so that products of a same order may be stacked with each other.

In some embodiments, the stack manager 110 is configured to implement a layer-by-layer process to determine the stacking arrangement. The stack manager 110 is configured to select, from the products identified in the job data, a first subset of products and form a first layer for the loading area 16, according to some embodiments. The stack manager 110 may select the largest products (in terms of footprint) as the first subset in order to establish robust columns. In some embodiments, the stack manager 110 is configured to perform an optimization to determine a first arrangement of where to place each of the first subset of products 22 as the first or base layer in a space efficient manner. Once the stack manager 110 determines the first arrangement for the first layer (formed by the first subset of products 22), the stack manager 110 selects a second subset of the remaining products 22 (excluding the first subset of products selected for the first layer), and performs a similar optimization to determine a second arrangement of where to place each of the second subsets of products 22 relative to the first layer of products 22, according to some embodiments. The stack manager 110 may use the size of each of the products 22 in the first layer as a constraint on where the products 22 of the second subset can be placed such that larger products 22 are not placed on top of smaller products 22. The stack manager 110 may repeat these techniques for a third, fourth, fifth, etc., subset of the products 22 until all the products 22 requested in the job data are exhausted. In this implementation, each of the subsets of products 22 selected from the entirety of the products 22 requested in the job data correspond to a different layer, according to some embodiments.

In some embodiments, the stack manager 110 is configured to determine the stacking arrangement in a column-by-column process. For example, the stack manager 110 may select a first subset of the products 22 requested in the job data and determine a first column by implementing an optimization to stack the first subset of products 22 into the first column while using space constraints of the loading area 16 effectively. Likewise, the stack manager 110 may select a second subset of the products 22 and determine a second column by implementing a similar optimization. The stack manager 110 may repeat this process, determining columns while ensuring that larger products 22 are not placed on top of smaller products 22, until all the products 22 are exhausted from the job data. The stack manager 110 may then determine an arrangement in horizontal dimensions about the loading area 16 to determine where the columns should be located in the loading area 16. Determining the stacking arrangement can also include determining a corresponding location for each of the products 22.

The stack manager 110 is configured to provide the stacking arrangement to a sequence manager 112 for use in determining a product sequence or order, according to some embodiments. The sequence manager 112 uses the stacking arrangement and determines either a layer-by-layer sequence, or a column-by-column sequence, according to some embodiments. For example, the sequence manager 112 may begin with all the products 22 on the first layer (e.g., the bottom layer), and determine a sequence of both production or manufacturing and placement for each of the products 22 in the first layer. The sequence manager 112 may output a product sequence (e.g., of both production and placement or movement from the processing machinery 12 to the loading zone 16) as well as target locations for each of the products 22 in the first layer. The sequence manager 112 may also determine a sequence of products 22 in the second layer, third layer, etc., and concatenate all the sequences to determine the product sequence. The product sequence is provided to the control manager 114, according to some embodiments. In the layer-by-layer sequence, the products 22 are manufactured and stacked successively (without requiring movement of a previously placed product 22) such that the layers are formed, according to some embodiments. For example, the first layer is first formed by placing the products 22 according to the product sequence, then the second layer is formed, etc., according to some embodiments.

In the column-by-column sequence, the sequence manager 112 determines a sequence in which to produce or manufacture and stack the products 22 in order to sequentially form the columns, according to some embodiments. For example, the sequence manager 112 may determine a first sequence in order to produce or manufacture the products 22 and stack the products 22 to form the first column of the stacking arrangement. For example, starting with the bottom or first layer, then the second layer, then the third layer, etc., the sequence manager 112 determines a first sequence to stack the products 22 to form the first column. The sequence manager 112 repeats this process for a second column, a third column, etc., of the stacking arrangement, according to some embodiments. The sequence manager 112 may concatenate these sequences to determine the product sequence. When operating according to the column-by-column product sequence, the columns are formed sequentially in the loading zone 16, according to some embodiments.

The control manager 114 is configured to receive the product sequence and the stacking arrangement and generate control signals for the robotic apparatus 18, according to some embodiments. The control manager 114 may output the product sequence or control signals to the processing machinery 12, or a system of controllers, manufacturing stations, etc. The processing machinery 12 uses the product sequence in order to produce the products indicated in the job data according to the product sequence. The robotic apparatus 18 is operated according to the control signals determined by the control manager 114 based on the product sequence such that the manufacture of the products 22 and the operation of the robotic apparatus 18 are in sync with each other (e.g., the processing machinery 12 and the robotic apparatus 18 operate in a coordinated manner), according to some embodiments. The control manager 114 is also configured to receive feedback from the processing machinery 12 (e.g., indicating a status or completion of production of each of the products 22 in order), and adjust operation of the robotic apparatus 18 based on the feedback from the processing machinery 12, according to some embodiments. The control manager 114 can operate the robotic apparatus 18 based on feedback from a vision system (e.g., indicating that a next product 22 is ready for placement and to move the product 22 to the target location). The control manager 114 uses the target location for each of the products 22 and the product sequence in order to move each product 22 in order from the processing machinery 12 to the target location in the loading zone 16. Advantageously, the controller 102 facilitates coordination between the manufacture or processing of the products 22 and the stacking of the products 22 in order to ensure optimal coordination between the processing machinery 12 and the robotic apparatus 18. The control manager 114 is configured to operate the robotic apparatus 18 such that subsequent products 22 that are produced can be moved to their target locations in the loading zone 16 without requiring moving or adjusting the position of previously placed products in the loading zone 16.

Referring still to FIG. 6, the display manager 116 is configured to receive controls (e.g., the control signals, the product sequence, etc.) from the control manager 114 and the stacking arrangement from the stack manager 110, according to some embodiments. The display manager 116 is also configured to receive the feedback from the processing machinery 12, according to some embodiments. The display manager 116 is configured to use the controls, the stacking arrangement, and the feedback to generate one or more user interfaces for the user computer 118, or for computers, display screens, systems, etc., of the processing machinery 12. In some embodiments, the display manager 116 uses the feedback and the controls to determine a status of completion of the job data. For example, the display manager 116 may generate graphical representations of the stacking arrangement, and/or a graphical representation of current completion of the stacking arrangement for the job data. The display manager 116 may also provide job data including number of products 22, types of products 22, target locations of each product 22, size of products, etc., on the user interfaces.

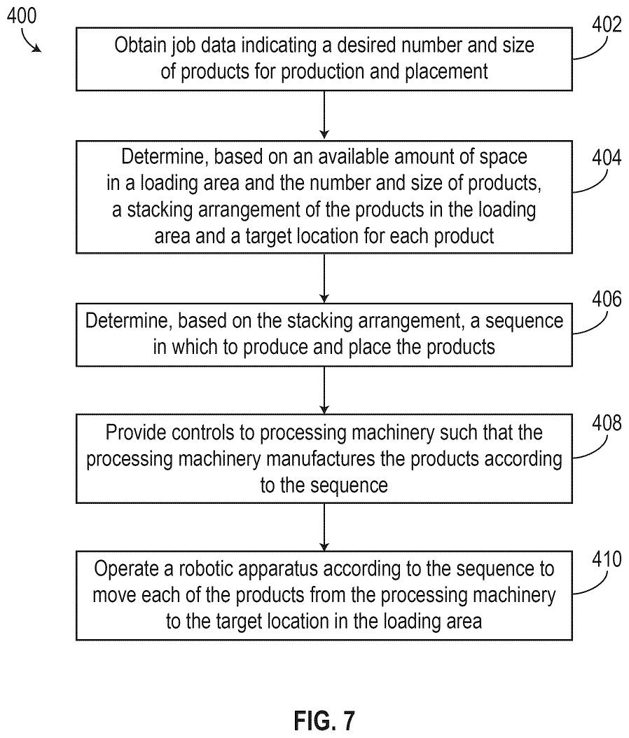

Referring to FIG. 7, a flow diagram of a method 400 for producing and sorting products includes steps 402-410, according to some embodiments. The method 400 can be performed by the processing system 10. The processing system 10 is configured to produce various products (e.g., copper bars, bulk materials cut to specific sizes, pipes, etc.). The processing system 10 may be configured to use raw materials and refine, process, cut, punch, laser etch, etc., the raw materials to produce the products. The products may be commercial materials such as beams, bars, pipes, plastics, etc. The products may also be consumer products, automotive products, etc., or any other product.

The method 400 includes obtaining job data indicating a desired number and size of products for production and placement (step 402), according to some embodiments. The job data may include various order data from different customers or a single customer. For example, the job data might indicate that a customer desires 100 products having various sizes for a construction project. Step 402 may be performed by the user computer 118 either automatically (e.g., responsive to entry at a web portal where customers can place orders), or by manual entry by a system manager (e.g., a plant manager).

The method 400 includes determining, based on an available amount of space in a loading area and the number and size of products, a stacking arrangement of the products in the loading area and a target location for each product (step 404), according to some embodiments. Step 404 may be performed by the controller 102, or more particularly, by the stack manager 110. The stacking arrangement may be performed by the stack manager 110 to determine a final or desired arrangement of all of the products requested in the job data. The desired arrangement may include various columns of one or more products stacked on top of each other, and locations in X and Y locations relative to each other. The desired arrangement may also include multiple layers of products. Step 404 may include determining a first arrangement of a first subset of the products that optimizes usage of an available amount of space within a first layer of the loading area, determining a second arrangement of a second subset of the products that optimizes usage of an available amount of space within a second layer of the loading area, and determining an arrangement of the second layer relative to the first layer in the loading area. In some embodiments, the second layer includes the second subset of the products forming the second layer stacked on top of the first subset of the products that form the first layer. Step 404 may include determining a first column of a first subset of the products stacked on top of each other, determining a second column of a second subset of the products stacked on top of each other, and determining an arrangement of the first column relative to the second column that optimizes usage of an available amount of space within the loading area. The loading area can be a three-dimensional space. The stacking arrangement can include a three-dimensional location of each of multiple products within the loading area.

The method 400 also includes determining, based on the stacking arrangement, a sequence in which to produce and place the products (step 406), according to some embodiments. Step 406 may be performed by the sequence manager 112 of the controller 102. Step 406 may include determining a layer-by-layer sequence in which the layers of the stacking arrangement are formed successively, or a column-by-column sequence in which the columns of the stacking arrangement are formed successively. The sequence may indicate both an order in which to produce the products requested in the job data, and an order in which to stack or place the products (e.g., by moving the products from the processing machinery 12 to the loading area 16).

The method 400 includes providing controls to processing machinery such that the processing machinery manufactures the products according to the sequence (step 408), according to some embodiments. In some embodiments, step 408 includes providing the sequence to the processing machinery 12. The processing machinery 12 uses the sequence in order to process, manufacture, cut, laser etch, etc., the products according to the sequence, according to some embodiments.

The method 400 includes operating a robotic apparatus according to the sequence to move each of the products from the processing machinery to the target location in the loading area (step 410), according to some embodiments. In some embodiments, step 410 is performed by the control manager 114 by providing control signals to the robotic apparatus 18. Step 410 may be performed based on both the sequence determined in step 406 and the target locations determined in step 404. In some embodiments, step 410 includes controlling the robotic apparatus 18 as each product is completed to move the product from an output of the processing machinery 12 to the target location of the loading area 16 according to the sequence.

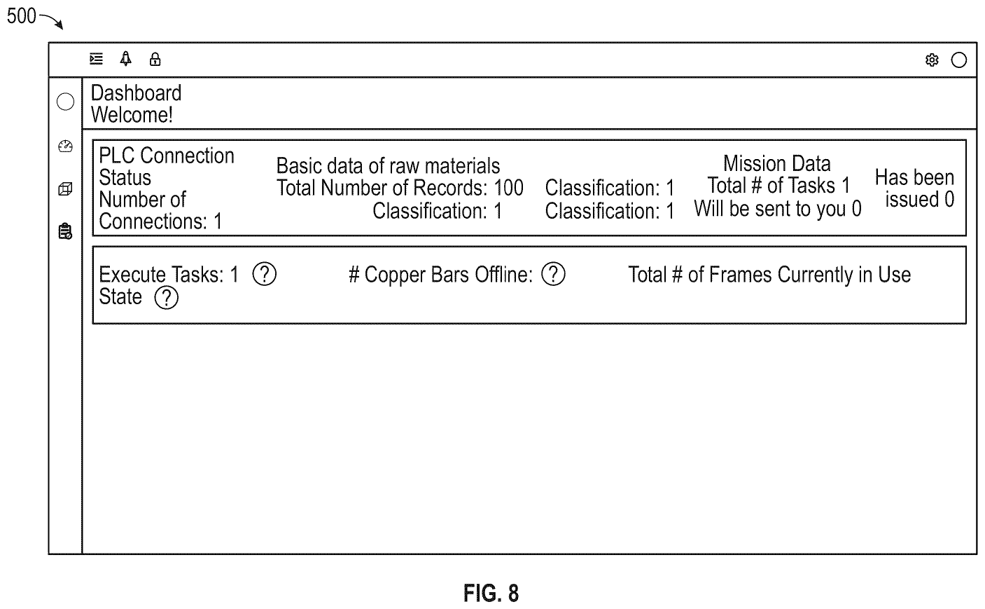

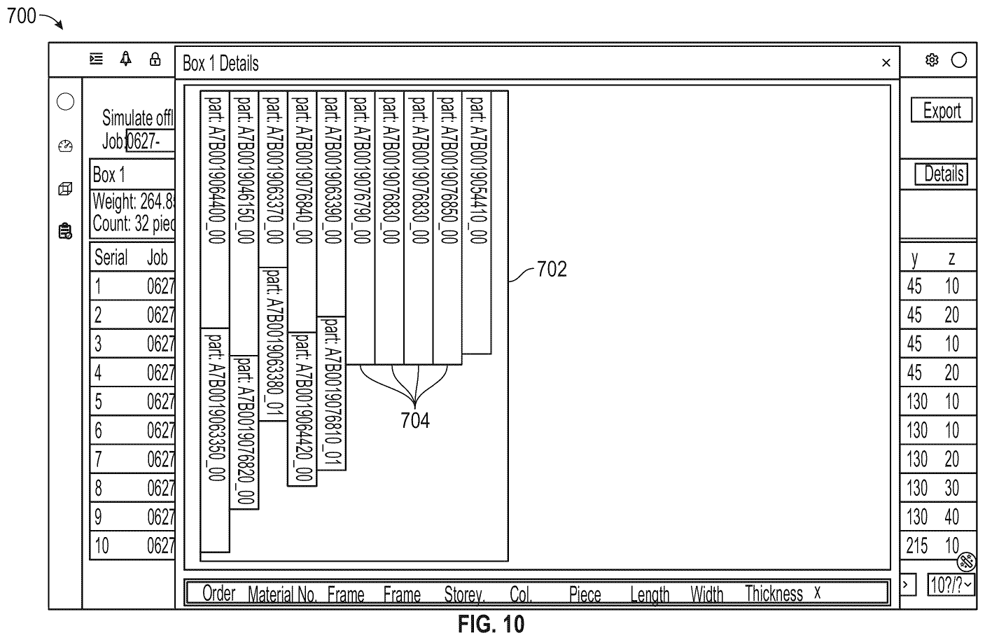

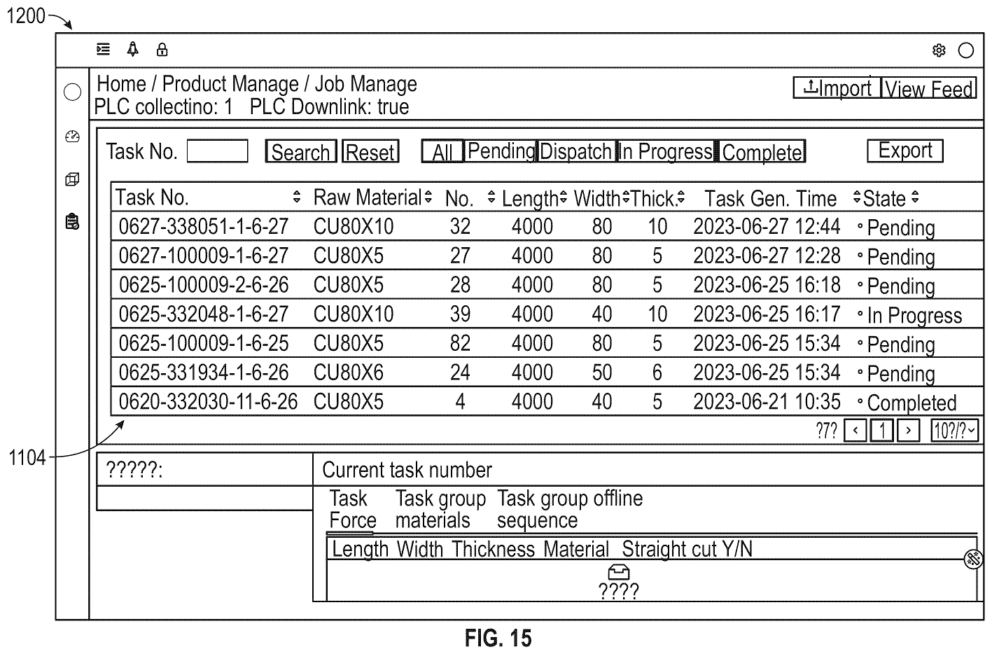

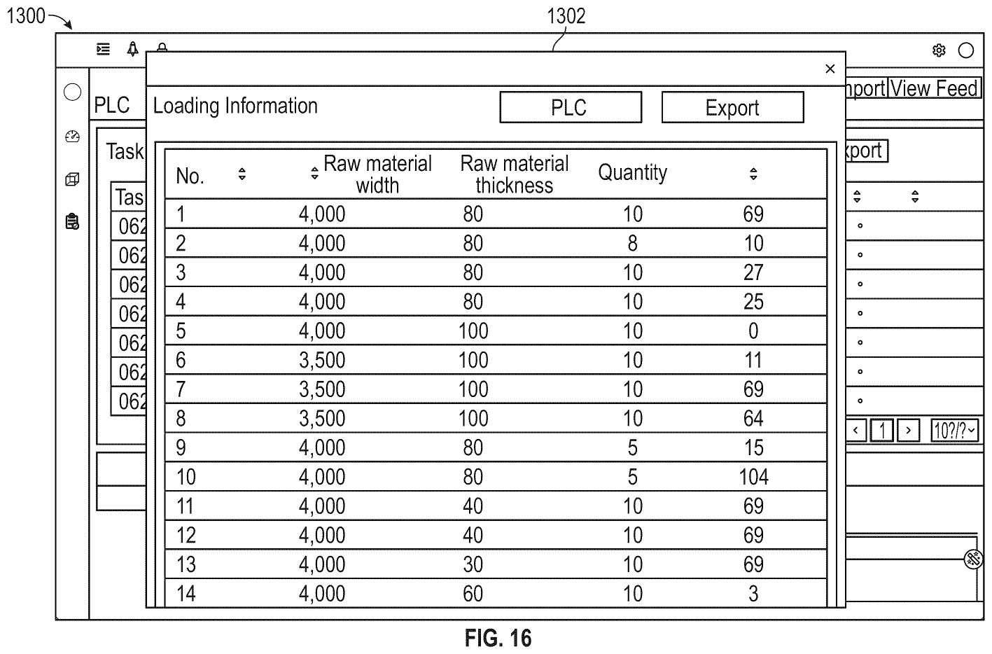

Referring to FIGS. 8-18, various graphical user interfaces that are presented on the user computer 118 are shown, according to some embodiments. The graphical user interfaces facilitate various dashboards to display status of the system 10, provide product loading or sorting data, initiate method 400, monitor status of various sub-systems or sorting of the products 22, skipping abnormal or damaged products 22, change frames of the boxes 302, outputting data logs, importing tasks or jobs, view current orders, or view bill of material information, according to some embodiments.

Referring particularly to FIG. 8, a graphical user interface (“GUI”) 800 provides a dashboard that may be displayed on the user computer 118. The GUI 800 provides real-time information regarding the entire product manufacturing and processing implemented by the system 10, according to some embodiments. In some embodiments, the GUI 800 provides information regarding communication status of the user computer 118 with the controller 102 (e.g., implemented as a programmable logic controller), status and information of orders that are currently being processed, loading of raw materials (e.g., input resources 20), and unloading and sorting of finished parts (e.g., the products 22).

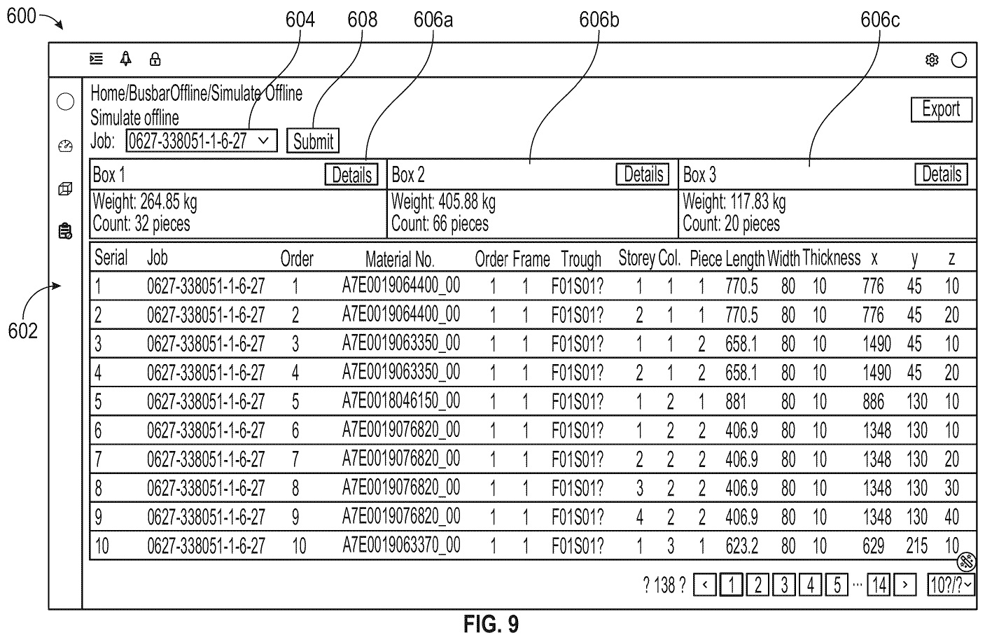

Referring particularly to FIG. 9, a GUI 900 provides a list 602 of products 22, with corresponding serial numbers and associated job number. The GUI 900 includes a dropdown menu 604 that a user may select to toggle between different jobs or job numbers. When different job numbers are selected from the dropdown menu 604, the list 602 is updated to illustrate corresponding products 22 for the selected job, according to some embodiments. In some embodiments, the list 602 includes dimensions, predicted weight, target location, what layer or column each of the products 22 should be placed in, the product sequence, etc. The GUI 900 advantageously displays results of finished product blanking, palletizing, and sorting generated by the stack manager 110 and the sequence manager 112 based on the job data obtained by the controller 102. In some embodiments, the user may also initiate the functionality of the stack manager 110 and the sequence manager 112 via GUI 900. For example, when the user selects the job data or job number from the dropdown menu 604, the stack manager 110 and the sequence manager 112 may retrieve the corresponding job data and implement their functionality to determine the stacking arrangement and the product sequence for display in the list 602. In some embodiments, the user must also select a submit button 608 that, when selected, initiates the functionality of the stack manager 110 and the sequence manager 112. In some embodiments, the GUI 900, once the controller 102 implements the product blanking, palletizing, and sorting, displays the results in list 602.

Referring still to FIG. 9, the GUI 900 may include different windows or panes, shown as window 606a, window 606b, and window 606c, that illustrate the weight and number of products 22 in each corresponding box of the loading area 16, or different loading areas. In some embodiments, each of the windows 606 can be selected in order to open a new window or display another GUI that visualizes the stacking arrangement for the different boxes. In particular, selection of the windows 606 causes presentation of GUI 700 including a window 702 that shows different visual indications 704 (e.g., icons, blocks, etc.) indicating positions of the different products 22 in the loading area 16.

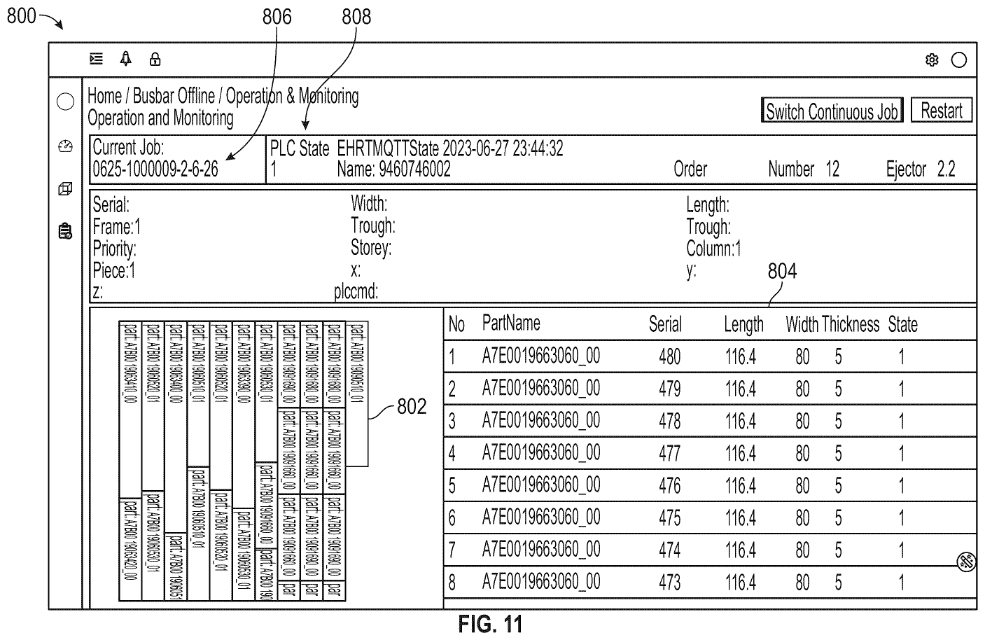

Referring to FIG. 11, a GUI 800 provides information regarding product unloading and monitoring in real-time, according to some embodiments. In some embodiments, the GUI 800 provides real-time palletizing and unloading information. The GUI 800 includes a currently executed work order number 806, a status of the controller 102 (e.g., a communications status), real-time communications status of the controller 102 with the processing machinery 12 (e.g., CNC machine tools), real-time processing information transmitted by the processing machinery 12, current processing part information (window 804), and palletizing and sorting information of currently finished parts (window 802). Advantageously, the GUI 800 provides real-time information regarding the functionality of the system 10 such that an operator or administrator can ensure that the system 10 is operating properly.

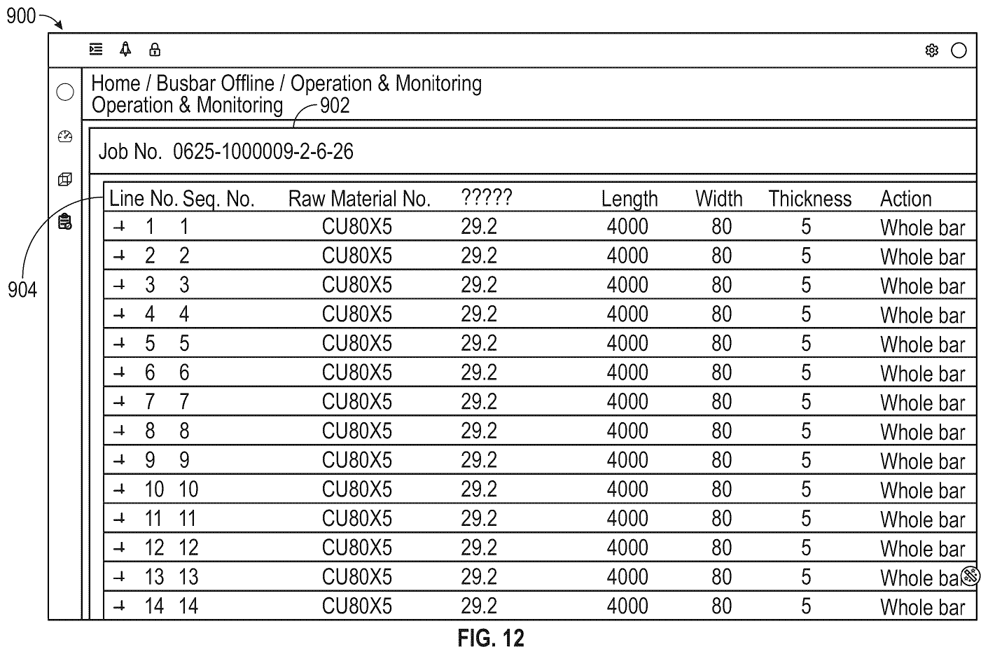

Referring to FIG. 12, a GUI 900 illustrates a list 904 of products for a job number 902, according to some embodiments. The GUI 900 facilitates skipping a part if an abnormality is detected. Manual palletizing and sorting may be required when continuous work order processing is interrupted, if the processing machinery 12 loses connectivity or experiences other abnormalities, if the processing machinery 12 fails, etc. The user may navigate via GUI 900 to identify products 22 that require manual palletizing and sorting, and to re-initiate fully automatic loading, unloading, and sorting after troubleshooting and resolving system errors or faults. The user may first check a serial number of the raw material currently being processed, click an entire jump piece on a previous base material, expand the raw material currently being processed in the list 904, and jump to the part number that is currently being processed by the processing machinery 12.

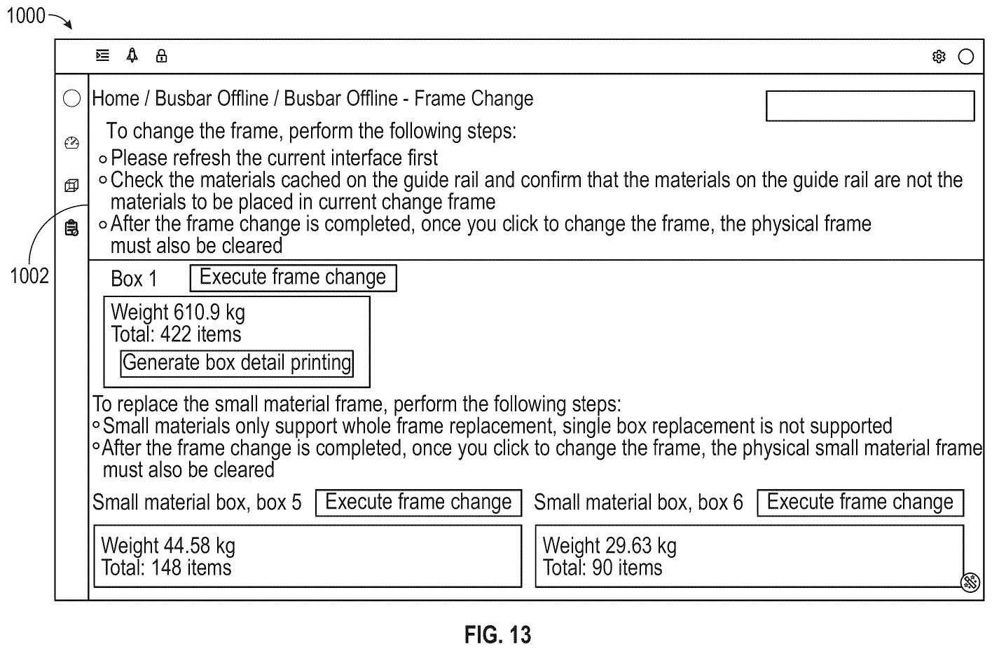

Referring to FIG. 13, a GUI 1000 provides instructions for changing the frame or the boxes 302a-302e once a box or frame becomes filled and requires removal (e.g., for delivery). When this occurs, the frame may need to be replaced with an empty frame before proceeding with fulfilling the next job order. The GUI 1000 includes textual information 1002 that provide step-by-step instructions to change the frame or the boxes 302a-302e. The GUI 1000 may automatically be presented to the user via the user computer 118 once a job is completed and the corresponding box 302 is filled. In some embodiments, the user may also query the current and historical logs of finished products 22 or jobs (e.g., sorting results for different orders or boxes) by searching via GUI 1000. The user may export information in an Excel or other data format for analysis and viewing.

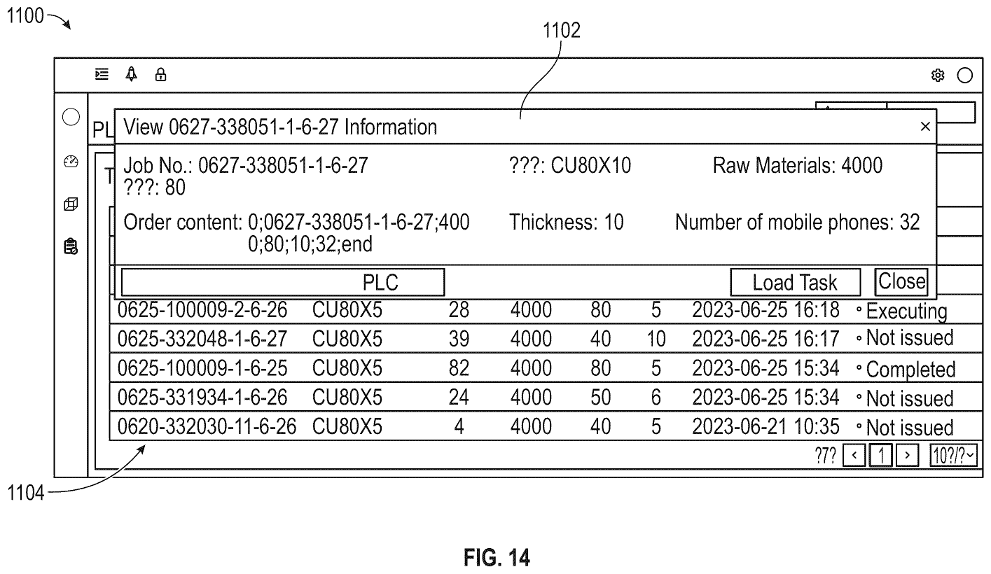

Referring to FIGS. 14-16, GUIs 1100, 1200, and 1300 allow the user to import work orders (e.g., the job data) and execute work order tasks. The GUI 1100 and the GUI 1200 include a job list 1104 that includes different jobs that, when selected by the user, cause the GUI 1100 to present a window 1102 indicating various information regarding the job. The user may select a load task button from the window 1102 in order to load the job data for the job and initiate the functionality of the stack manager 110 and the sequence manager 112. In some embodiments, the user may import a work orders by selecting an import task button on the GUI 1100, importing a corresponding work order job file (e.g., generated by a factory system), and viewing a corresponding task to cause the window 1102 to be presented to the user. The user may then select the load task button in the window 1102 to initiate the functionality of the stack manager 110 and the sequence manager 112 and to provide controls to the robotic apparatus 18 (e.g., to a loading gantry hammock). The user may also view execution statuses of historical work orders in the list 1104 or view loading location inventory in order to view inventory status of a raw material warehouse. If the user selects a current task from the list 1104, the controller 102 may parse out raw material and finished product information of the selected work order (e.g., the selected job) and present the raw material and finished product information for viewing by the user, as shown in window 1302 of GUI 1300.

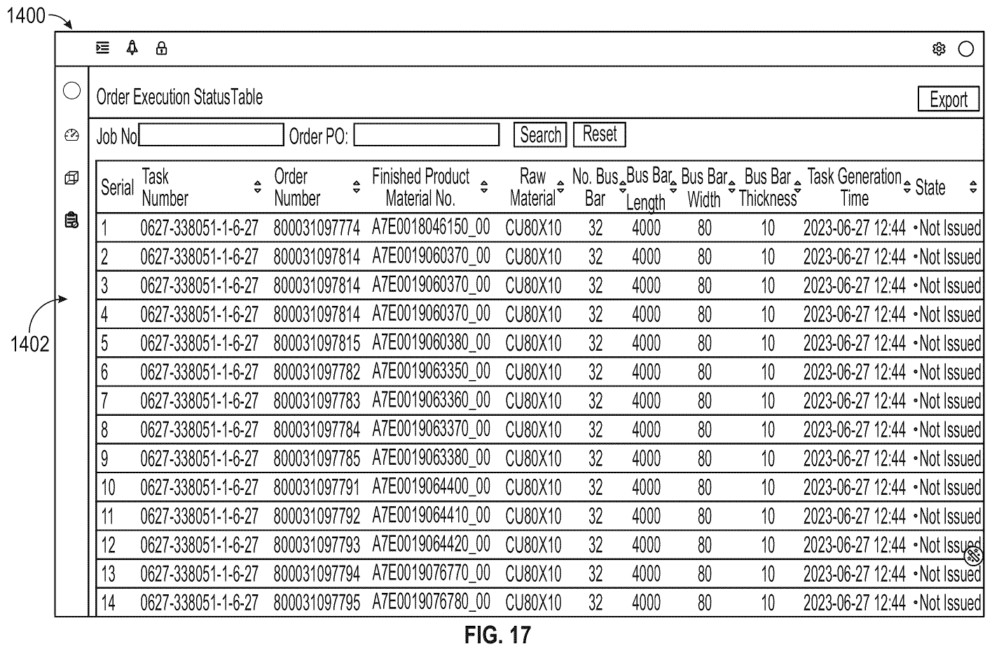

Referring to FIG. 17, a GUI 1400 provides information (e.g., a list 1402) indicating current and historical work orders. The user may select any of the lines of the list 1402 in order to view current or historical work orders, search or query for specific work orders, and export work order data for further analysis.

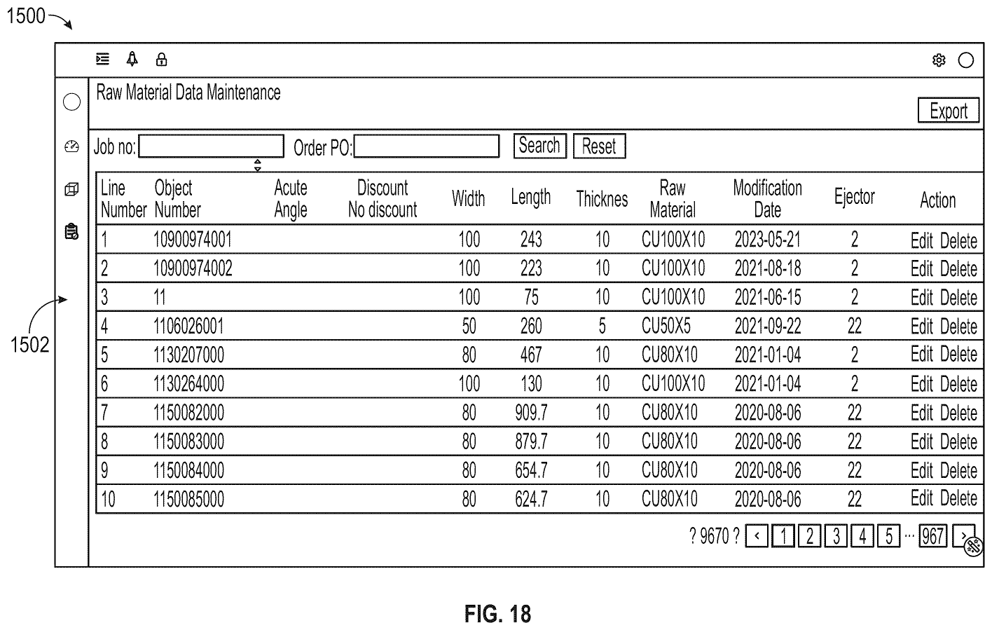

Referring to FIG. 18, a GUI 1500 illustrates information of various raw materials that are usable by the processing machinery 12, according to some embodiments. The GUI 1500 includes a table 1502 of different raw or unrefined materials that the processing machinery 12 can use to produce the products 22. The raw material in the table 1502 may be imported manually by the user or may be imported automatically by synchronizing the controller 102 with a factory system.

### Configuration of the Exemplary Embodiments

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the systems and components shown in the various exemplary embodiments is illustrative only. Additionally, any element disclosed in one embodiment may be incorporated or utilized with any other embodiment disclosed herein. For example, the techniques and controls of the control signal generator 318 of the exemplary embodiment shown in at least FIG. 12 may be incorporated in the segment controllers 50 of the exemplary embodiment shown in at least FIG. 8. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A method for producing and sorting a plurality of products, the method comprising:
obtaining job data indicating a size and number of each of the plurality of products to be produced and sorted;
determining, based on both (i) the size and number of each of the plurality of products, and (ii) an available amount of space in a loading area, an order of production for the plurality of products;
causing a manufacturing system to produce each of the plurality of products according to the order of production; and
operating a robotic apparatus to move each of the plurality of products into a target location in the loading area based on the order of production of the plurality of products.

2. The method of claim 1, wherein determining the order of production for the plurality of products comprises:
determining a stacking arrangement for the plurality of products based on the size and number of each of the plurality of products and the available amount of space in the loading area; and
determining the order of production determined based on the stacking arrangement.

3. The method of claim 2, wherein determining the stacking arrangement comprises:
determining a first arrangement of a first subset of the plurality of products that optimizes usage of an available amount of space within a first layer of the loading area;
determining a second arrangement of a second subset of the plurality of products that optimizes usage of an available amount of space within a second layer of the loading area; and
determining an arrangement of the second layer relative to the first layer in the loading area, wherein the second layer comprises the second subset of the plurality of products forming the second layer stacked on top of the first subset of the plurality of products that form the first layer.

4. The method of claim 2, wherein determining the stacking arrangement comprises:
determining a first column of a first subset of the plurality of products stacked on top of each other;
determining a second column of a second subset of the plurality of products stacked on top of each other; and
determining an arrangement of the first column relative to the second column that optimizes usage of an available amount of space within the loading area.

5. The method of claim 2, wherein determining the stacking arrangement comprises performing an optimization process that optimizes a use of the available amount of space in the loading area by stacking smaller products on top of larger products.

6. The method of claim 2, wherein the loading area comprises a three-dimensional space and the stacking arrangement comprises a three-dimensional location of each of the plurality of products within the three-dimensional space.

7. The method of claim 1, wherein the manufacturing system comprises a computer numerical control (CNC) system.

8. The method of claim 1, wherein one or more of the plurality of products comprise a different shape or a different size than at least one other of the plurality of products.

9. The method of claim 1, further comprising determining the target location of each of the plurality of products within the available amount of space, wherein the robotic apparatus is configured to move each of the plurality of products to the target location as the plurality of products are produced.

10. The method of claim 9, wherein the target location of each of the plurality of products is determined based on a division of the available amount of space in the loading area into a plurality of three-dimensional subspaces.

11. The method of claim 1, wherein the order of production causes the manufacturing system to produce the plurality of products in a sequence that allows the robotic apparatus to move each of the plurality of products to a corresponding location in the loading area as each of the plurality of products are provided in sequence without requiring rearrangement of any other of the plurality of products produced previously.

12. A system for producing and sorting a plurality of products, the system comprising:
a manufacturing system configured to output the plurality of products;
a loading area defining a space within which the plurality of products can be stored;
a robotic implement configured to move each of the plurality of products to a target location in the loading area; and
processing circuitry configured to:
obtain job data indicating a size and quantity of the plurality of products;
determining, based on the size and quantity of the plurality of products and the space of the loading area, a production order of the plurality of products, and the target location for each of the plurality of products within the loading area;
provide the production order of the plurality of products to the manufacturing system to cause the manufacturing system to produce the plurality of products according to the production order; and
operate the robotic implement based on both the production order and the target location for each of the plurality of products to move each of the plurality of products to the target location of the loading area.

13. The system of claim 12, wherein the size of each of the plurality of products comprises a three-dimensional size indicating a volume of space that each of the plurality of products will occupy when placed at the target location in the loading area.

14. The system of claim 12, wherein the target location is determined by the processing circuitry by dividing the loading area into a plurality of boxes, each of the plurality of boxes divided into slots, columns, blocks, and levels, the target location including an indication of which of other of the plurality of products a corresponding product is stacked upon.

15. The system of claim 12, wherein determining the target location for each of the plurality of products comprises a position of each of the plurality of products in one or more stacks of the plurality of products.

16. The system of claim 12, wherein the processing circuitry is further configured to:
communicate with the manufacturing system and the robotic implement to obtain feedback indicating progress of a completion of a job for the job data; and
operate a user interface to display the progress of the job including a graphical representation of the plurality of products each positioned at the target locations in the loading area.

17. A non-transitory computer readable medium configured to store instructions that, when executed by at least one processor, cause the at least one processor to perform operations comprising:
obtaining job data indicating a size and number of each of a plurality of products to be produced and sorted;
determining, based on both (i) the size and number of each of a plurality of products, and (ii) an available amount of space in a loading area, an order of production for the plurality of products;
causing a manufacturing system to produce each of the plurality of products according to the order of production; and
operating a robotic apparatus to move each of the plurality of products into a target location in the loading area based on the order of production of the plurality of products.

18. The non-transitory computer readable medium of claim 17, wherein determining the order of production for the plurality of products comprises:
determining a stacking arrangement for the plurality of products based on the size and number of each of the plurality of products and the available amount of space in the loading area; and
determining the order of production determined based on the stacking arrangement.

19. The non-transitory computer readable medium of claim 18, wherein determining the stacking arrangement comprises:
determining a first arrangement of a first subset of the plurality of products that optimizes usage of an available amount of space within a first layer of the loading area;
determining a second arrangement of a second subset of the plurality of products that optimizes usage of an available amount of space within a second layer of the loading area; and
determining an arrangement of the second layer relative to the first layer in the loading area, wherein the second layer comprises the second subset of the plurality of products forming the second layer stacked on top of the first subset of the plurality of products that form the first layer.

20. The non-transitory computer readable medium of claim 18, wherein determining the stacking arrangement comprises:
determining a first column of a first subset of the plurality of products stacked on top of each other;
determining a second column of a second subset of the plurality of products stacked on top of each other; and
determining an arrangement of the first column relative to the second column that optimizes usage of an available amount of space within the loading area.
